(19) United States
(12) Patent Application Publication
(10) Pub. No.: US 2020/0154862 A1
(43) Pub. Date: May 21, 2020

(54) RETAINING APPARATUSES COMPRISING CONNECTORS

(71) Applicant: HEWLETT-PACKARD DEVELOPMENT COMPANY, L.P., Spring, TX (US)

(72) Inventor: Chern-Shi Lam, Taipei (TW)

(21) Appl. No.: 16/482,292

(22) PCT Filed: Jul. 20, 2017
(86) PCT No.: PCT/US2017/043000

§ 371 Date: Jul. 31, 2019

(51) Int. Cl. A45F 3/04; H01R 13/60; G06F 1/16

(52) U.S. Cl. CPC A45F 3/04; H01R 13/60; A45F 2003/003; G06F 1/1683; G06F 1/163

(57) ABSTRACT

Examples of retaining apparatus for computing units are described. In an example, a retaining apparatus comprises a strap to body-mount a computing unit on a user. Further, the retaining apparatus comprises a connector integrated with the strap. The connector is to communicatively couple the computing unit to a peripheral device.

### BACKGROUND

With the advent of technology, compact computing devices possess high computational capabilities and have become ubiquitous. Owing to their compactness, portability of the computing devices is enhanced and users carry their computing devices on themselves not merely to transport the devices from one place to another but also while using the devices, for instance, while playing games involving interaction with a virtual reality environment.

One example of a portable, high capability computing device that may be carried around by a user while being used for purposes such as gaming, is a personal computer (PC). Such a PC, also known as backpack PC, is often carried by a user in a bag pack. The PC is securely held in the bag pack while straps of the bag pack support the PC on the user's back. Connectors are provided to couple the bag pack PC to peripherals, such as head-mounted displays and headphones.

### BRIEF DESCRIPTION OF FIGURES

The following detailed description references the drawings, wherein:

FIG. 1 schematically illustrates a computing device according to an example implementation of present subject matter;

FIG. 2 illustrates a retaining apparatus for the computing device in accordance with an example implementation of present subject matter;

FIG. 3 illustrates the retaining apparatus, in accordance with another example implementation of the present subject matter;

FIG. 4 illustrates a connector to be integrated in a strap of the retaining apparatus in accordance with an example implementation of present subject matter;

FIG. 5 illustrates a cable of the connector according to an example implementation of present subject matter;

FIG. 6 illustrates a strap of the retaining apparatus in accordance with an example implementation of present subject matter; and

FIG. 7 illustrates the strap of the retaining apparatus in accordance with an example implementation of present subject matter.

### DETAILED DESCRIPTION

Computing devices are used by users for various purposes, such as for virtual reality based applications where an artificial environment is generated by a computing device and users are enabled to interact with the artificial environment.

A computing device used for virtual reality applications generally comprises a computing unit that generates the virtual reality content and peripherals that render the virtual reality content. The computing unit may be a bag pack personal computer (PC), such that a user is able to carry the PC on his back with the help of straps provided on the bag pack. Connectors are provided to couple the computing unit to the peripherals. For example, the computing unit may be coupled to a head-mounted display, to provide power and audio-video signals to the head-mounted display for displaying the virtual reality content.

Presence of multiple connectors, for example, a plurality of connectors each carrying audio, video, data and power signals, between the computing unit and a given peripheral often impacts the ease of use of the computing device for the users. Further, in using the computing device for applications like playing a virtual reality based game or exploring a simulated virtual environment, where the users often move, the presence of the multiple connectors may hinder the mobility of the users. In some cases, the movements may also cause disconnection of the connectors resulting in poor user experience. For instance, if a High-Definition Multimedia Interface (HDMI) connector coupling the computing unit to the head-mounted display gets disconnected, the display may have to be restarted.

Further, generally, a connector provided to couple the computing unit to the peripherals has a fixed length. The fixed length may be inconvenient to use for different users given that the users may be of different heights. If the fixed length is kept sufficiently long to facilitate use by tall users, the same may be excessive for many other users. The excess length may cause a hindrance during use for such users. In cases where the fixed length is insufficient, it may result in strain on the connector.

Users may often also face inconvenience in using single-part connectors that are generally incorporated in computing devices. A user may find attaching the single-part connector to a computing unit after wearing the same on his back difficult. Accordingly, the user may attach the single-part connector to the computing unit prior to wearing the computing unit on his back. Thus, the single-part connector remains hanging loose at one end when the user is wearing the computing unit and may cause obstruction to the user or may get tugged and disconnected from the computing unit.

According to various aspects of the present subject matter, a retaining apparatus for a computing unit is described. In an example, the retaining apparatus comprises a strap to body-mount the computing unit on a user. The retaining apparatus also comprises a connector having a cable integrated with the strap. The cable transmits data, power and audio-video signals from the computing unit to a peripheral device.

In an example implementation, a maximum length of the connector is kept sufficiently long to facilitate use by tall users. Upon the maximum length of the connector being shortened, a corresponding excess length of the connector is retained within the strap.

According to example implementations of the present subject matter, computing devices comprising the retaining apparatus are described. In an example, the retaining apparatus comprises a strap for holding the computing unit of a computing device. The strap can be placed around a shoulder of a user to secure the computing unit on the user. The retaining apparatus further comprises a connector integrated with the strap to communicatively couple the computing unit to a peripheral device, wherein a part of the connector is secured within the strap.

Integration of the connector with the strap enhances the ease of use of the computing device. Also, allowing a part of the connector to be secured within the strap provides for a connector having a sufficiently long length to be incorporated in the computing device. This avoids strain on the connector as well as prevents a situation where an excess length of the connector protrudes externally, potentially causing hindrance to a user. Further, in one implementation, the connector transmits audio-video, power, as well as data signals between the computing unit and a peripheral device, thereby eliminating the incorporation of multiple connectors.

Further, in an example implementation, the connector is a two-part connector comprising a first cable that is to attach to the computing unit and second cable that is to attach to a peripheral. The first cable and the second cable are detachably attachable through a first and a second electrical coupler. The two-part connector is easier to use as opposed to single-part connectors that are generally incorporated in computing devices. In accordance with an example implementation, a user may connect the first cable to the computing unit and put the straps on to the mount the computing unit on his back. The first cable integrated with the strap does not dangle loosely and cannot cause the problem relating to obstruction as explained above.

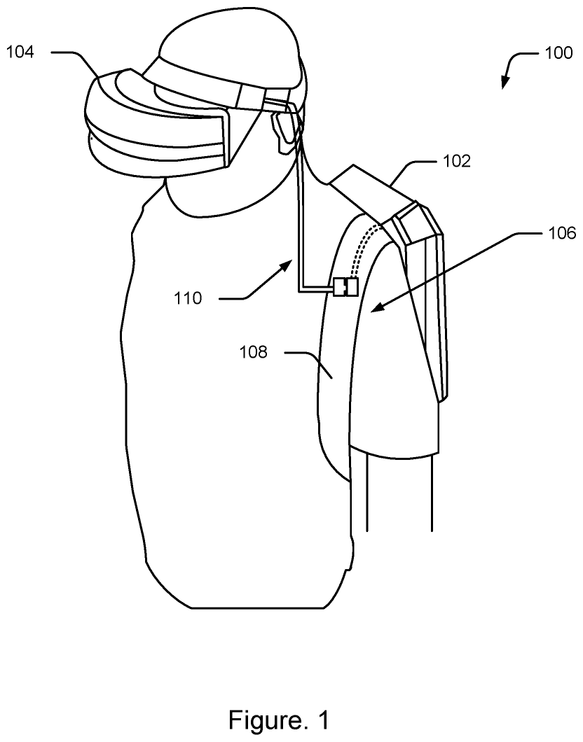

The above described computing devices and retaining apparatus are further described with reference to FIGS. 1 to 7. It should be noted that the description and figures merely illustrate the principles of the present subject matter along with examples described herein and, should not be construed as a limitation to the present subject matter. It is thus noted that various arrangements may be devised that, although not explicitly described or shown herein, describe the principles of the present subject matter. Moreover, all statements herein reciting principles, aspects, and examples of the present subject matter, as well as specific examples thereof, are intended to encompass equivalents thereof.

FIG. 1 schematically illustrates a computing device 100 according to an example implementation of present subject matter. In an example, the computing device 100 is a virtual reality (VR) device that may be used, among others, for gaming purposes. The computing device 100 comprises a computing unit 102. In an example, the computing unit 102 is a personal computer (PC), such as a bag pack PC. As illustrated in the figure, the computing unit 102 may be carried by the user like a bag pack. A peripheral device 104 of the computing device 100 is coupled to the computing unit 102 to render content generated by the computing unit 102. The peripheral device 104 may be a head-gear or a headphone, for example. The head-gear may comprise a head-mounted display to display a video content. In some examples, the head-mounted display may comprise an integrated earphone to output an audio content.

Though depicted as a head-mounted peripheral device in accordance with the example implementation shown in FIG. 1, the peripheral device 104 may also be a hand-held peripheral device.

In an example implementation, the computing device 100 also comprises a retaining apparatus 106. The retaining apparatus 106 has a strap 108 to hold the computing unit 102. The strap 108 is used to body-mount the computing unit 102 on the user. The length of the strap is adjustable. Accordingly, the strap 108 is also interchangeably referred to as length adjustable strap 108. A connector 110 is integrated with the strap 108 to communicatively couple the computing unit 102 to the peripheral device 104. The connector 110 is integrated such that a part of the connector 110 is secured within the strap 108.

Accordingly, the length of the connector 110 may be varied by retaining a portion of the connector 110 within the strap 108. Varying the length provides for relieving strain on the connector 110 and also restrains an excess length of the connector 110 that may cause interference to activities of the user.

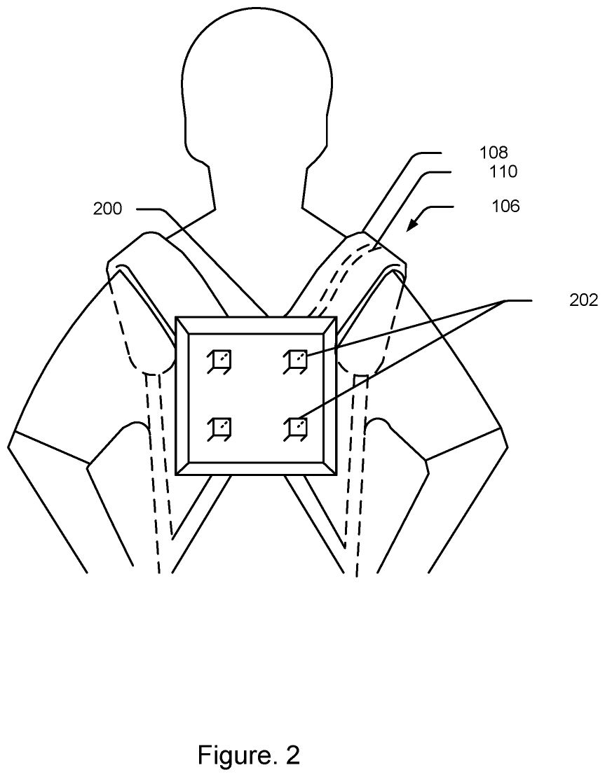

FIG. 2 illustrates the retaining apparatus 106 in accordance with an example implementation of present subject matter. In an example, the retaining apparatus 106 comprises a holding compartment 200 to accommodate the computing unit 102. The holding compartment 200 may comprise a variety of devices that may store the computing unit 102. In an example, the holding compartment 200 may be a back pack comprising an interior compartment where the computing unit 102 may be placed. The strap 108 may be connected to the exterior of the interior compartment.

In another example implementation, the computing unit 102, such as a PC may be directly attached to the holding compartment 200. In such example implementations, the holding compartment 200 includes supporting members 202 that mate with corresponding supporting members provided on the computing unit 102 to mount the computing unit 102 on the holding compartment 200. In one example, the supporting members 202 may be protrusions 202 provided on the surface of the holding compartment 200. The computing unit 102 may in turn include grooves that may accommodate the protrusions 202 to allow attachment and detachment of the computing unit 102 with the holding compartment 200.

The length adjustable strap 108 is attached to the holding compartment 200. The strap 108 can be placed around a shoulder of a user to securely transport the holding compartment 200 by carrying by the user. The strap 108 may be made length adjustable, for example, by incorporating a buckle (not shown in figures) that permits a user to shorten or lengthen the strap 108 as desired. The buckle provides for length adjustment by anchoring a withdrawn portion of the strap 108 at a position set by the user.

The connector 110 is integrated with the length adjustable strap 108. In an example, a maximum length of the connector 110 may correspond to a maximum length of the length adjustable strap 108. A maximum length of the strap 108 accounts for the tallest of users and, thus, having the maximum length of the connector 110 in accordance with the maximum length of the strap 108 ensures that the connector 110 is sufficiently long. In another example, a maximum length of the connector 110 may correspond to a maximum distance that may exist between the computing unit 102 and a peripheral device 104. As explained above, a sufficiently long connector 110 may provide for relieving strain on the connector 110.

While the maximum length of the connector 110 is kept sufficiently long to facilitate use by tall users, other users may find the maximum length of the connector 110 excessive and may reduce the same, for example, in accordance with their height, during usage. The excess length of the connector 110 may be understood as the length reduced from the maximum length. A portion of the connector 110 is secured within the strap 108, such that upon the maximum length of the connector 110 being shortened, the corresponding excess length of the connector 110 is retained within the strap 108. The excess length of the connector 110 is prevented from protruding out and a situation where the connector 110 may inadvertently get tugged by the user resulting in disconnection of the connector 110 from the computing unit 102 is avoided.

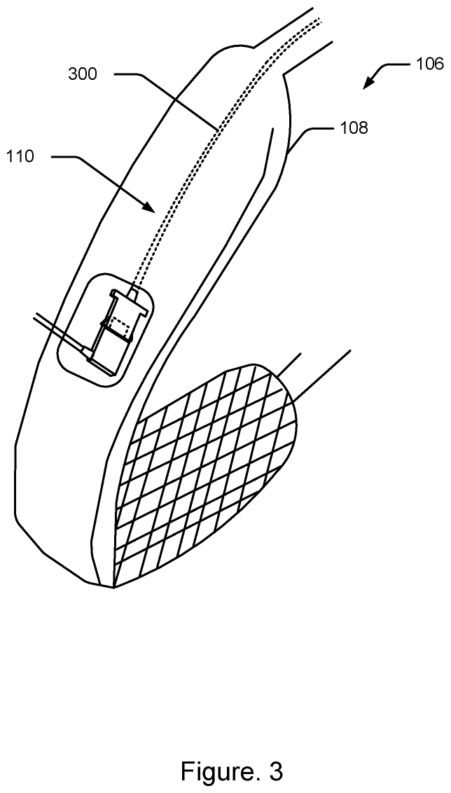

Alike FIG. 2, FIG. 3 also illustrates the retaining apparatus 106 in accordance with an example implementation of present subject matter. In the example implementation illustrated in FIG. 3, the retaining apparatus 106 comprises the strap 108, which secures the computing unit 102 on the user, and the connector 110. The connector 110 comprises a cable 300 to transmit data, power and audio-video signals from the computing unit 102 to the peripheral device 104. The cable 300 is integrated with the strap 108. In an example, the cable 300 may be integrated with the strap 108 by affixing the cable 300 onto an exterior upper surface of the strap 108. Example implementations elaborating integration of the cable 300 within the strap 108 have been described subsequently.

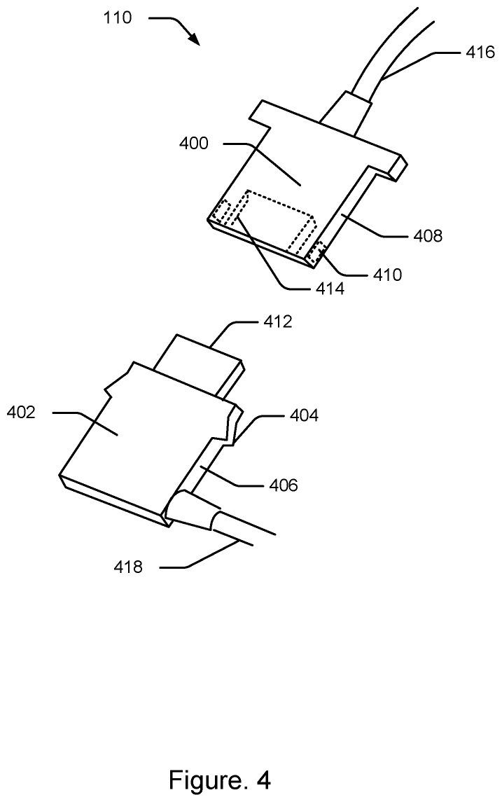

FIG. 4 illustrates the connector 110 in accordance with an example implementation of present subject matter. In an example, the connector 110 comprises a first electrical coupler 400. The first electrical coupler 400 may be attached to a second electrical coupler 402. The first and the second electrical coupler 400 and 402 are detachably attachable, for example, by a latch 404 that may be provided on an outer housing of either of the first or second electrical coupler 400 and 402. In the illustrated example implementation, an outer housing 406 of the second electrical coupler 402 includes the latch 404. Accordingly, an outer housing 408 of the first electrical coupler 400 comprise openings 410 to accommodate the latch 404.

In an example implementation, the first electrical coupler 400 is a female type coupler and the second electrical coupler 402 is a male type coupler, such that a male-female coupling may be established between them for communicative coupling of the first electrical coupler 400 and the second electrical coupler 402. The example implementation illustrated in FIG. 4, depicts a male connector 412 provided in the second electrical coupler 402 that engages with a corresponding female connector 414 implemented in the first electrical coupler 400 to establish the male-female coupling.

The first electrical coupler 400 is attached to a first cable 416 that in turn attaches to the computing unit 102. In other words, the first cable 416 couples the computing unit 102 to the first electrical coupler 400. For example, the first cable 416 is the above-explained cable 300. Similarly, a second cable 418 is attached to the peripheral device 104 at one end and to the second electrical coupler 402 at another end. The second cable 418 allows communicative coupling of the computing unit 102 with the peripheral device 104, when the first electrical coupler 400 is attached to the second electrical coupler 402 in operation.

In an example, implementing a two-part connector 110, considering the first electrical coupler 400 with the first cable 416 attached to it as a first part and the second electrical coupler 402 with the second cable 418 as the second part, provides for ease of use of the computing device 100. Having the first part of the connector 110 integrated with the strap 108 is simple in use as compared to an arrangement where a single part-part connector is used. A user may find attaching the single part-part connector to a computing unit 102 on his back and to a head-gear cumbersome. In such a case, the user may attempt to attach the single part-part connector to the computing unit prior to him mounting the computing unit on his back. This results in a situation where the single part-part connector remains dangling from the computing unit 102, causing obstruction to the user while putting-on the computing unit 102 on his back.

In an example, the first cable 416 is substantially perpendicular to the second cable 418. The first cable 416 emerges from the computing unit 102 and interfaces with the outer housing 408 of the first electrical coupler 400. Likewise, the second cable 418 exits from the outer housing 406 of the second electrical coupler 402 to connect to the peripheral device 104. The direction of exit of the second cable 418 from the outer housing 406 of the second electrical coupler 402, is substantially perpendicular to the direction of the first cable 416 interfacing with the outer housing 408 of the first electrical coupler 400. As mentioned above, in several example implementations of the present subject matter, the peripheral device 104 is a head-mounted peripheral device. The substantially perpendicular direction of exit of the second cable 418 provides for the second cable 418 to be positioned in an upward direction towards the head-mounted peripheral device.

In an example implementation, the first cable 416 is the cable 300 explained above in context of FIG. 3. The first cable 416 is to transmit data, power and audio-video signals from the computing unit 102 to the first electrical coupler 400. When the first electrical coupler 400 is attached to the second electrical coupler 402, the second cable 418 further transmits the data, power and audio-video signals from the computing unit 102 to the peripheral device 104.

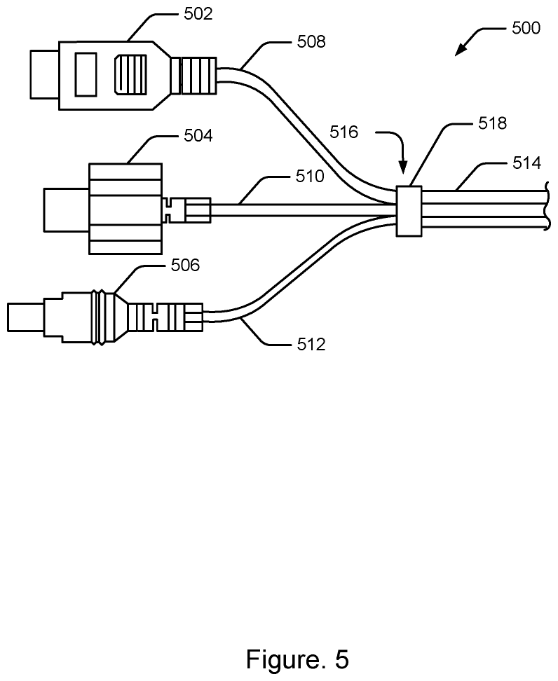

FIG. 5 illustrates a cable 500 of the connector 110 according to an example implementation of present subject matter. For example, the cable 500 is the above explained cable 300 and the first cable 416 integrated in the strap 108 to transmit data, power and audio-video signals from the computing unit 102 to the first electrical coupler 400 and in turn to the peripheral device 104.

In an example, the cable 500 comprises I/O port interfaces, such as a data I/O port interface 502, an audio-video I/O port interface 504, and a power I/O port interface 506 that interface with corresponding I/O ports of the computing unit 102. In an example implementation, the audio-video I/O port interface 504 is a High-Definition Multimedia Interface (HDMI) interface and the data I/O port interface 502 is a Universal Serial Bus (USB) based interface that couple to a HDMI and USB I/O port of the computing unit 102, respectively.

As illustrated, connectors 508, 510 and 512 emerging from the HDMI, USB and power I/O port interfaces, integrate into a composite cable 514 at an integration point 516. In an example, the integration point 516 may be adjustable, for example, by a sliding coupler 518 that holds the connectors 508, 510 and 512 together. While the integration point 516 may be present at any point along the length of the cable 500, in an implementation, the integration point 516 is maintained close to the computing unit 102.

The first electrical coupler 400 too comprises an audio-video interface, a data and a power interface (not shown) corresponding to the audio-video I/O port interface 504, data I/O port interface 502 and power I/O port interface 506. For instance, the female connector 414 of the first electrical coupler 400 may comprise I/O pins that serve as the interfaces. A predefined number of pins may be provided on the female connector 414, in accordance with the audio-video, data and power transmit protocol implemented between the computing unit 102 and the peripheral device 104. In an example, the female connector 414 may comprise 19 I/O pins as HDMI interface.

Accordingly, the second electrical coupler 402 comprises interfaces that are in accordance with the interfaces of the first electrical coupler 400. Further, as will be understood, the second cable 418 attached to the second electrical coupler 402 also comprises I/O port interfaces that interface with corresponding I/O ports of the peripheral device 104. In the example where the interfaces are I/O pins, upon coupling of the first and the second electrical coupler 400 and 402, the I/O pins of the female connector 414 mate with that of the male connector 412 to transmit data, power and audio-video signals from the computing unit 102 to the peripheral device 104.

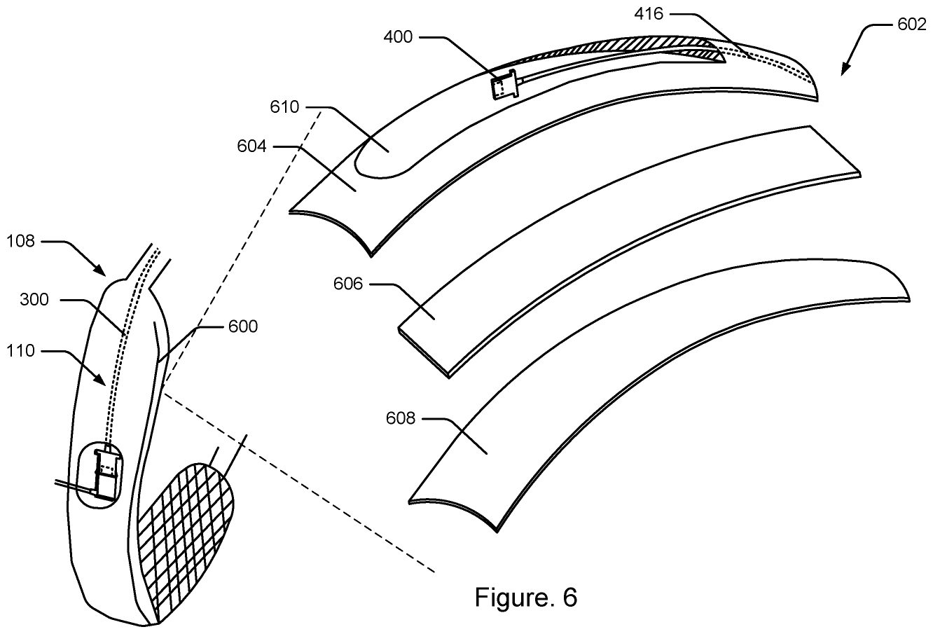

FIG. 6 illustrates the strap 108 of the retaining apparatus 106 in accordance with an example implementation of present subject matter. In an example, the strap 108 comprises a multi-layered padded portion 600. A part of the connector 110, i.e., the cable 300 or the first cable 416 as explained above, is integrated with the strap 108 to transmit data, power and audio-video signals from the computing unit 102 to the peripheral device 104.

The multi-layered padded portion 600 may comprise multiple layers 602. The integration of the first cable 416 may be such that a substantial length of the first cable 416 is covered by any of the layers 602 of the multi-layered padded portion 600.

In accordance with an example implementation, as illustrated, the multi-layered padded portion 600 comprises an upper outer layer 604, a padding layer 606 and a lower inner layer 608. In an example, an opening 610 is provided on the upper outer layer 604. While the integration of the first cable 416 allows a part of the first cable 416, for example, an excess length of the first cable 416, to remain covered within the multi-layered padded portion 600, the first electrical coupler 400 attached to the first cable 416 protrudes out of the opening 610.

The positioning of the opening 610 in front of the strap 108 provides for easy access of the first cable 416 by a user. Also, by providing the opening 610 high on the strap 108, the length of the second cable 418 may be kept significantly short, since a little additional length of the second cable 418 is sufficient to connect the first electrical coupler 400 to a peripheral device 104 which is a head-mounted peripheral device. The reduced length of the second cable 418 and in turn that of the connector 110 avoid having a long cable that obstructs movement of the user or gets tangled.

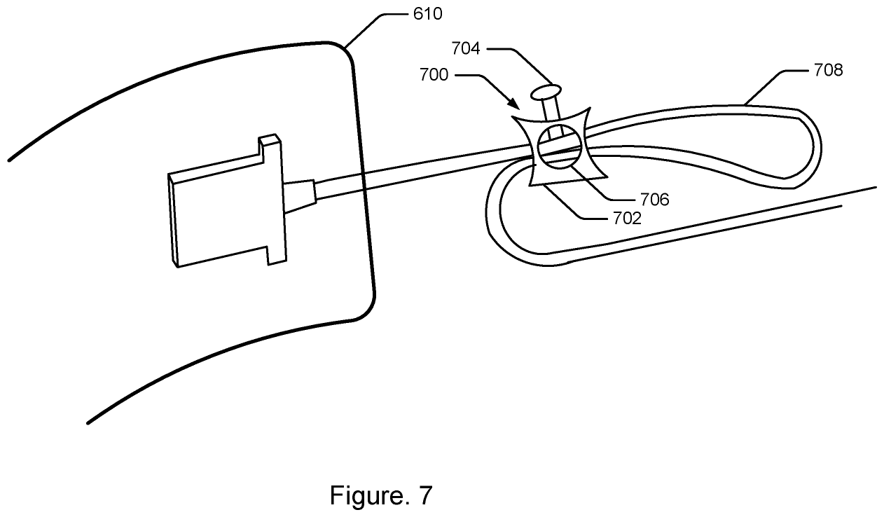

In an implementation, the first cable 416, may have an additional length to provide for lengthening or shortening the length of the connector 110, for example, based on the height of a user. The excess length is retractably retained within the strap 108, covered within the multi-layered padded portion 600, and may be withdrawn per use. In an example implementation, the first cable 416 placed within the strap 108 may be a retractable cable (not shown). For instance, the retractable cable may be a spirally-coiled cable that may be elongated upon pulling by a user and shortened by allowing the retractable cable to collapse. On collapsing of the retractable cable, the excess length of the first cable 416 is contained substantially within the multi-layered padded portion 600. The excess length of the first cable 416 in various other example implementations may also be secured within the strap 108 based on techniques explained with reference to FIG. 7 below.

FIG. 7 illustrates a portion of the strap 108 in accordance with another example implementation of present subject matter. As explained previously, an excess length of the first cable 416 and in turn that of the connector 110 may be secured within the strap 108.

While a variety of techniques, for example, a string (not shown) that may tie-up a portion of the first cable 416, may be implemented to secure the excess length within the strap 108, in an example implementation, as illustrated in FIG. 7, a latch 700 is used for the purpose. In an example, the latch 700 is a length adjustment buckle that provides for shortening the length of the first cable 416 by withdrawing a portion of the same.

In accordance with an example implementation, the latch 700 comprises a cable holder 702 associated with a lock 704. A user may operate the lock 704 to withdraw a portion of the first cable 416 through an opening 706 of the cable holder 702. The withdrawn portion may form a loop 708 that is anchored by the lock 704 by constraining the opening 706. In operation, the user may withdraw the latch 700 outside from the opening 610 to make the length adjustment and then insert the latch 700 along with the loop 706 back within the strap 108 such that the excess length is retained within the strap 108 and is covered within the multi-layered padded portion 600.

In another example implementation, the strap 108 may comprise a zippered pouch (not shown). The zippered pouch may be used in a manner similar to the latch 700. An excess length of the first cable 416 may be pulled out of the opening 610 and inserted in the zippered pouch to secure the same. The zippered pouch is then inserted into the opening 610 to be contained within the strap 108.

Securing the excess length of the first cable 416 provides for the connector 110 to have a long length, such that the length of the connector 110 may correspond to a maximum length of the strap 108 to account for tall users. When the length of the strap 108 is shortened by a user, for example, in accordance with the height of the user, the user may also wish to reduce the length of the connector 110. Similarly, when a user increases a previously shortened the length of the strap 108, the user may wish to increase the length of the connector 110.

In accordance with the example implementation described above, the length of the connector 110 is made length adjustable to allow the users to perform such adjustments on the length of the connector 110. As explained above, the excess length of the connector 110 corresponding to the shortened length of the strap 108 may be secured within the strap 108. Further, the length of the connector 110 secured within the strap 108 may be released by the user on increasing the length of the strap 108. With the length of the connector 110 being made adjustable, strain on the connector is avoided. Also, issues relating to hindrance to users due to the excess length of the connector 110 are addressed.

Although implementations for computer devices and retaining apparatuses have been described in a language specific to structural features and/or methods, it is to be understood that the appended claims are not necessarily limited to the specific features or methods described. Rather, the specific features and methods are disclosed as example implementations for the computer devices and retaining apparatuses.

I/We claim:

1. A computing device comprising:
a computing unit;
a peripheral device to be coupled to the computing unit, wherein the peripheral device is to render content generated by the computing unit; and
a retaining apparatus comprising:
a strap to hold the computing unit, wherein the strap is to be placed around a shoulder of a user to securely transport the computing unit by carrying by the user; and
a connector integrated with the strap to communicatively couple the computing unit to the peripheral device, wherein a part of the connector is secured within the strap.

2. The computing device as claimed in claim 1, wherein the connector comprises:
a first and a second electrical coupler, the first and the second electrical coupler being detachably attachable;
a first cable to attach to the computing unit at one end and the first electrical coupler at the other end; and
a second cable to attach to the peripheral device at one end and the second electrical coupler at the other end.

3. The computing device as claimed in claim 2, wherein the first cable is a retractable cable.

4. The computing device as claimed in claim 2, wherein the strap comprises a multi-layered padded portion, a substantial length of the first cable being covered by a layer of the multi-layered padded portion.

5. The computing device as claimed in claim 1, wherein the computing device is a virtual-reality device and the peripheral device is a head-mounted peripheral device.

6. A retaining apparatus for a computing unit, the retaining apparatus comprising:
a holding compartment to accommodate the computing unit;
a length adjustable strap connected to the holding compartment; and
a connector integrated with the strap, wherein the connector is to connect the computing unit and a peripheral device, and wherein a portion of the connector is secured within the strap such that upon a maximum length of the connector being shortened, a corresponding excess length of the connector is retained within the strap.

7. The retaining apparatus as claimed in claim 6, wherein the strap comprises one of a zippered pouch and a latch to restrain the excess length of the connector within the strap.

8. The retaining apparatus as claimed in claim 6, wherein the connector comprises:
a first cable to attach to the computing unit at one end and to a first electrical coupler at another end; and
a second cable to attach to the peripheral device at one end and to a second electrical coupler at another end;
the first electrical coupler being attachable to the second electrical coupler to communicatively couple the computing unit to the peripheral device.

9. The retaining apparatus as claimed in claim 8, wherein the first cable attached to the first electrical coupler is substantially perpendicular to the second cable attached to the second electrical coupler.

10. The retaining apparatus as claimed in claim 8, wherein the first electrical coupler is a female type coupler and the second electrical coupler is a male type coupler, and wherein the communicative coupling between the first electrical coupler and the second electrical coupler is a male-female coupling.

11. The retaining apparatus as claimed in claim 8, wherein the first and the second electrical coupler comprises a plurality of interfaces and wherein the plurality of interfaces corresponds to an audio-video interface, a data and a power interface.

12. The retaining apparatus as claimed in claim 8, wherein the strap comprises:
a multi-layered padded portion with an opening provided on an upper outer layer of the multi-layered padded portion,
wherein a part of the first cable is secured within the multi-layered padded portion and the first electrical coupler of the first cable is to protrude out of the opening.

13. A retaining apparatus comprising:
a strap to body-mount a computing unit on a user; and
a connector comprising:
a cable integrated with the strap, the cable to transmit data, power and audio-video signals from the computing unit to a peripheral device.

14. The retaining apparatus as claimed in claim 13, wherein the strap covers a part of the cable such that an excess length of the cable is retractably retained within the strap.

15. The retaining apparatus as claimed in claim 13, wherein the cable comprises I/O port interfaces to connect to a High-Definition Multimedia Interface (HDMI) port of the computing unit, an Universal Serial Bus (USB) port of the computing unit, and a power I/O port of the computing unit.
